(19) United States
(12) Patent Application Publication
(10) Pub. No.: US 2008/0083609 A1
(43) Pub. Date: Apr. 10, 2008

(54) OXYGEN CONDITIONING OF PLASMA VESSELS

(75) Inventors: Shou-Qian Shao, Winchester, MA (US); Jack Jerome Schuss, Newton, MA (US); John Thomas Summerson, Reading, MA (US); William M. Holber, Winchester, MA (US); Thomas M. Parrill, Andover, MA (US)

Correspondence Address: PROSKAUER ROSE LLP, ONE INTERNATIONAL PLACE, BOSTON, MA, 02110, US

(73) Assignee: MKS Instruments, Inc., Wilmington, MA (US)

(21) Appl. No.: 11/867,342

(22) Filed: Oct. 4, 2007

Related U.S. Application Data
(63) Continuation-in-part of application No. 11/543,248, filed on Oct. 4, 2006.

(51) Int. Cl. H05H 1/24

(52) U.S. Cl. 204/164

(57) ABSTRACT

Methods and apparatus for operating plasmas are described. The vessel receives an oxygen containing plasma to clean and/or condition the vessel. Some embodiments of the invention feature methods and apparatus for improving ignition properties of the plasmas.

### CROSS-REFERENCE TO RELATED APPLICATION

The present application is a continuation-in-part of U.S. patent application Ser. No. 11/543,248, filed Oct. 4, 2006, the entire disclosure of which is incorporated herein by reference.

### FIELD OF THE TECHNOLOGY

The technology relates generally to plasma generation and processing equipment. In particular, the technology relates to methods and apparatus for operating plasmas in quartz, sapphire, and/or aluminum vessels.

### BACKGROUND OF THE TECHNOLOGY

Plasmas are often used to activate gases placing them in an excited state such that the gases have an enhanced reactivity. In some cases, the gases are excited to produce dissociated gases containing ions, free radicals, atoms and molecules. Dissociated gases are used for numerous industrial and scientific applications including processing solid materials such as semiconductor wafers, powders, and other gases. The parameters of the dissociated gas and the conditions of the exposure of the dissociated gas to the material being processed vary widely depending on the application. Significant amounts of power are sometimes required in the plasma for dissociation to occur.

Plasma sources generate plasmas by, for example, applying an electric potential of sufficient magnitude to a plasma gas (e.g., O₂ N₂, Ar, NF₃, H₂ and He), or a mixture of gases, to ionize at least a portion of the gas. Plasmas can be generated in various ways, including DC discharge, radio frequency (RF) discharge, and microwave discharge. DC discharge plasmas are achieved by applying a potential between two electrodes in a plasma gas. RF discharge plasmas are achieved either by electrostatically or inductively coupling energy from a power supply into a plasma. Microwave discharge plasmas are achieved by directly coupling microwave energy through a microwave-passing window into a discharge chamber containing a plasma gas. Plasmas are typically contained within chambers that are composed of metallic materials such as aluminum or dielectric materials such as quartz, sapphire, yttrium oxide, a zirconium oxide, and/or an aluminum nitride.

There are applications in which an activated gas may not be compatible with the plasma source and/or the semiconductor processing system. For example, during semiconductor manufacturing, atomic oxygen is reacted with a photoresist to remove photoresist from a semiconductor wafer by converting the photoresist to volatile CO₂ and H₂O byproducts. Atomic oxygen is typically produced by dissociating O₂ (or a gas containing oxygen) with a plasma in a plasma chamber of a plasma source. The plasma chamber can be made of quartz, sapphire, and/or aluminum. The plasma chamber can include dielectric materials such as a yttrium oxide, a zirconium oxide, and/or an aluminum nitride. The plasma chamber can include a metal vessel coated with a dielectric material. Atomic fluorine is often used in conjunction with atomic oxygen because the atomic fluorine accelerates the photoresist removal process. Fluorine is generated by, for example, dissociating NF₃ or CF₄ with the plasma in the plasma chamber. Fluorine, however, is highly corrosive and can adversely react with the quartz chamber.

One application in which an activated gas is not compatible with a plasma chamber material involves a plasma comprising hydrogen located within a sapphire chamber. Excited hydrogen atoms and molecules can react with the sapphire (Al₂O₃) and convert the sapphire to aluminum. Changes in the material composition of the chamber can, for example, result in undesirable drift of the processing parameters and also in the formation of particles.

Another application in which an activated gas is not compatible with a plasma chamber material involves a plasma comprising hydrogen located within a quartz chamber. Excited hydrogen atoms and molecules can react with the quartz (SiO₂) and convert the quartz to silicon. Changes in the material composition of the chamber can, for example, result in undesirable drift of the processing parameters and also in the formation of particles. In other applications, the quartz can be converted into Si₃N₄ if nitrogen is present in the plasma chamber during processing.

Applications in which an activated gas is not compatible with a plasma chamber material include hydrogen containing plasma in a quartz chamber. Excited hydrogen atoms, hydrogen molecules, and/or hydrogen containing molecules can interact with the quartz (SiO₂), and can convert the quartz to silicon particles and/or silicon containing materials. These interactions can, for example, cause an undesirable drift of the processing parameters and/or particle formation. In one example, the quartz can be converted into SiₓN_{y} if nitrogen is also present along with hydrogen in the plasma chamber during processing.

Another application in which an activated gas is not compatible with a plasma chamber material includes hydrogen containing plasma in a sapphire chamber. Excited hydrogen atoms, hydrogen molecules, and/or hydrogen containing molecules can interact with the sapphire (Al₂O₃), and can convert the sapphire to aluminum and/or other aluminum containing materials. These interactions can, for example, cause an undesirable drift of the processing parameters and/or particle formation.

Another application in which an activated gas adversely affects a process involves using a forming gas. For example, in a process using an O₂ plasma gas in combination with a forming gas (e.g., 4% H₂ in N₂) in a photoresist strip process, the forming gas can retard, impair, or prevent ignition. In some instances, the use of a forming gas can retard, impair, or prevent ignition because the H₂ in the forming gas adversely interacts with the plasma vessel. Residual chemical species on the plasma vessel surface that result from such undesired reactivity retard, impair, or prevent one or more subsequent ignitions.

A need therefore exists for effectively dissociating a gas with a plasma in a manner that minimizes adverse effects of the dissociated gas on the plasma chamber.

### SUMMARY OF THE TECHNOLOGY

The technology generally features apparatus and methods that can provide improved operation of plasmas in quartz and/or sapphire vessels. An advantage of the technology is that plasmas having reactivity with quartz and/or sapphire can be operated in a quartz and/or sapphire vessel while minimizing the formation of undesired particles and/or corrosion of the vessel. Other advantages include the ability to operate such reactive plasmas for longer periods of time, at higher powers, at higher pressures, and at higher flow rates. The technology can improve and extend the operational lifetime for a quartz and/or sapphire vessel employed with such reactive plasmas. More generally, features of the invention enable a range of applications unavailable in prior plasma systems.

For example, the technology features apparatus and methods that can provide reliable operation of a water vapor containing plasma in a quartz vessel. An advantage of the technology is that water vapor containing plasmas can be operated in a quartz vessel while minimizing the formation of undesired particles. Other advantages include the ability to operate water vapor containing plasmas for longer periods of time, the ability to operate water vapor containing plasmas at higher powers, and improved operational lifetime for a quartz vessel employed with a water vapor containing plasma.

In one aspect, the technology features a method for operating a plasma. An oxygen containing plasma is generated. The plasma is provided to a plasma vessel including quartz, sapphire, aluminum and/or a dielectric material to clean and/or condition the vessel.

In another aspect, the technology features a method for operating a plasma. An oxygen containing gas is received in a plasma vessel including quartz, sapphire, and/or aluminum. An oxygen containing plasma is formed. The plasma cleans and/or conditions the vessel.

In yet another aspect, the technology features a method including receiving an oxygen containing plasma in a vessel, including quartz, sapphire, and/or aluminum, to clean and/or condition the vessel.

In another aspect, the technology features a method for operating a plasma. An oxygen containing plasma is provided to a vessel including quartz, sapphire, and/or aluminum. The plasma chemically and/or thermally interacts with the vessel to add oxygen to a surface of the quartz, sapphire, and/or aluminum.

In yet another aspect, the technology features a method including providing an oxygen containing plasma to a vessel including quartz, sapphire, and/or aluminum. The plasma chemically and/or thermally interacts with a contaminant in the vessel to remove the contaminant from a surface of the quartz, sapphire, and/or aluminum.

In another aspect, the technology features a method including providing an oxygen containing plasma to a vessel comprising quartz or sapphire or aluminum, the plasma chemically and/or thermally interacting with a contaminant in the vessel to remove the contaminant from surface of the vessel.

In another aspect, the technology features a method for operating a plasma. A gas including water is received in a quartz vessel. The gas is ignited to form a water vapor containing plasma for downstream processing. The quartz vessel also receives a conditioning gas including oxygen. An oxygen containing plasma is formed for conditioning the quartz vessel.

In various embodiments, the method can include one or more cycles where a first step of water vapor containing plasma operation is followed by a second step of oxygen containing plasma operation. In other various embodiments, the method can include mixing the gas including water and the gas including oxygen together.

In some embodiments, the vessel defines an enclosed toroidal channel.

In certain embodiments, the conditioning gas includes nitrogen.

In various embodiments, the method can include steps to abate erosion of the vessel. In some embodiments, abating erosion of the vessel is achieved by cooling the vessel. In various embodiments, abating erosion of the vessel is achieved by reducing a power associated with the water vapor containing plasma.

In another aspect, the technology features a method for operating a plasma by providing a vessel defining an enclosed channel. A gas including water is provided, and at least a portion of the gas is directed into the channel. The gas is ignited to form a water vapor containing plasma for downstream processing. A conditioning gas including oxygen is also provided. At least a portion of the conditioning gas is directed into the channel. An oxygen containing plasma is formed for conditioning the vessel.

In yet another aspect, the technology features a method for operating a plasma. A first gas is received in a vessel and the first gas is ignited to generate a plasma for downstream processing. A conditioning gas comprising oxygen is received in the vessel and an oxygen containing plasma is generated in the vessel.

In some embodiments, the first gas includes a forming gas. In some embodiments, the first gas includes hydrogen. The first gas can also include nitrogen. In some embodiments, the method involves extinguishing the plasma after generating the oxygen containing plasma. In some embodiments, the method involves reigniting the first gas to generate the plasma for downstream processing.

In another aspect, the technology features a method for operating a plasma. The method includes providing a vessel defining an enclosed channel, the vessel including at least one of quartz, sapphire, and aluminum. The method also includes providing a first gas, directing at least a portion of the first gas into the channel, and igniting the first gas to generate a plasma for downstream processing. The method further includes providing a conditioning gas comprising oxygen. The method further includes directing at least a portion of the conditioning gas into the channel and generating an oxygen containing plasma for conditioning the vessel.

Other aspects and advantages of the invention will become apparent from the following drawings, detailed description, and claims, all of which illustrate the principles of the invention, by way of example only.

### BRIEF DESCRIPTION OF THE DRAWINGS

This invention is described with particularity in the appended claims. The above and further advantages of this invention can be better understood by referring to the following description taken in conjunction with the accompanying drawings, in which:

FIG. 1 is a schematic view of a cross section of an embodiment of a toroidal plasma system.

FIG. 2A is a schematic top-view cross section of an embodiment of a portion of a plasma system.

FIG. 2B is a schematic side-view cross section of the embodiment of the portion of the plasma system of FIG. 2A.

FIG. 3 is top view of an embodiment of a plasma system that includes a linear-shaped vessel having a gas input port and an output port.

FIG. 4 is a top view of an embodiment of a plasma system that includes a toroidal-shaped vessel having a gas input port and an output port.

FIG. 5 is a block diagram of an embodiment of a plasma processing system.

FIG. 6 is a flowchart of an embodiment of a method for operating a plasma.

FIG. 7 shows a particle count as a function of plasma operation time in an oxygen containing plasma.

FIG. 8 shows a particle count as a function of plasma operation time in a water vapor containing plasma with an oxygen containing plasma.

FIG. 9 shows a particle count as a function of plasma operation time in a water vapor containing plasma with an oxygen containing plasma.

FIG. 10 shows a particle count as a function of plasma operation time in a new plasma vessel.

FIG. 11 is a flowchart of an embodiment of a method for operating a plasma.

### DETAILED DESCRIPTION OF THE TECHNOLOGY

A plasma system is an apparatus that includes plasma generation components, and can include materials processing components. A plasma system can include one or more vessels, power supply components, metrology components, control components, and other components. Processing can occur in one or more vessels and/or in one or more processing chambers in communication with the one or more vessels. A plasma system can be a source of plasma or reactive gas species generated in a plasma or can be a complete processing tool.

A vessel is a container or portion of a container that contains a gas and/or a plasma, and within which a plasma can be ignited and or/maintained. A toroidal vessel includes at least one dielectric portion, or is formed entirely of dielectric material. A vessel can also be referred to as a plasma body. A vessel is combined with other components, such as power generation and cooling components to form a plasma processing system. A vessel can define channels having a variety of shapes. For example, a channel can have a linear shape, or can have a loop shape (e.g., to support a toroidal plasma).

A channel is the volume defined and enclosed by a vessel. A channel can contain a gas and/or a plasma, and can be in communication with one or more input ports and one or more output ports of the vessel, for receiving and delivering gas and plasma species. A plasma system can include means to apply a DC or oscillating electric field within the channel. The electric field can maintain a plasma in the channel, and can, alone or in cooperation with other means, ignite a plasma in the channel.

A plasma is a state of matter that includes a collection of charged particles that are related to a gas. A plasma is a quasineutral, or approximately neutral collection of positive and negative ions. A plasma can include neutral atoms and/or molecules associated with the ionized species. A plasma can contain a significant fraction of un-ionized gas. The matter in a vessel, after ignition, is herein broadly referred to as a plasma without intending to limit such matter to that consisting solely of species in a plasma state.

A toroidal plasma is a plasma in the form of a closed path and with plasma current circulating in the closed path. A toroidal plasma can reside in a toroidal channel enclosed by a toroidal vessel.

Ignition is the process of causing an initial breakdown in a gas, to form a plasma.

An ignition electrode is an electrode that is capacitively coupled to a vessel, and to which a voltage can be applied for ignition of a gas in the vessel. An ignition voltage can be applied, for example, between an ignition electrode and a reference electrode or between an ignition electrode and a conductive portion of a vessel. One or more ignition electrodes can be adjacent to an inner or outer surface of a vessel (the illustrative embodiments described herein include ignition electrodes adjacent to an outer surface). An ignition electrode can be insulated from the plasma by a dielectric material (e.g., quartz, sapphire, and/or aluminum). In some embodiments, plasmas can be ignited by a UV light source.

Reference electrode refers to one or more electrodes and/or one or more conductive portions of a vessel that act in cooperation with one or more ignition electrodes.

Inert gases are gases that in many circumstances are non-reactive or have low reaction rates, including argon and the other noble gases.

Noble gases are a group of rare gases that include helium, neon, argon, krypton, xenon, and sometimes radon, and that exhibit chemical stability and low reaction rates.

A reactive gas is a gas containing some species that are prone to engage in one or more chemical reactions. Reactive gases include gases that are not inert gases.

An activated gas includes any of ions, free radicals, neutral reactive atoms and molecules.

A heat sink is a structure including one or more portions and/or components for absorption, dissipation and/or removal of heat. A heat sink can also be an electrode, for example, an ignition electrode and a reference electrode.

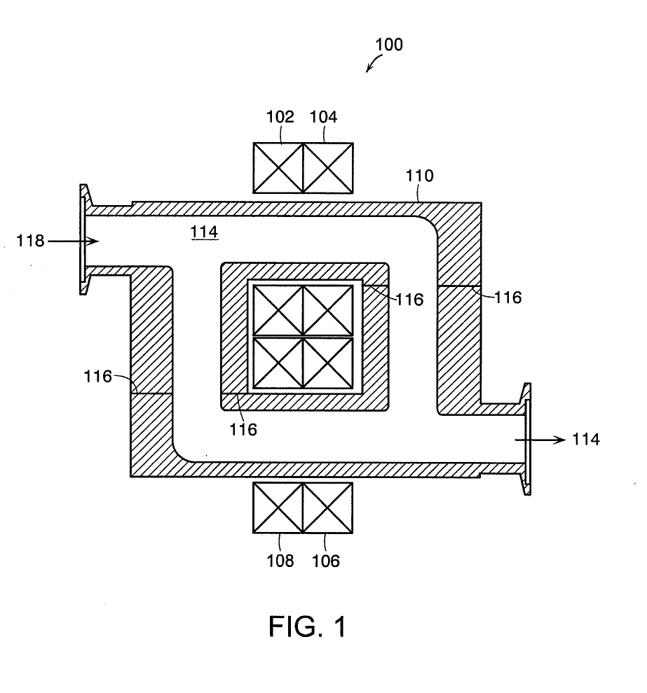

FIG. 1 is a cross-sectional schematic view of a portion of an embodiment of a toroidal plasma system 100. The portion includes a vessel 110 that defines a channel 114, magnetic cores 102, 104, 106, 108, a gas inlet 118, an outlet 119, and a mating surface 116.

The vessel 110 can be formed entirely from one or more dielectric materials, or can be formed from both conductive and dielectric materials. Appropriate conductive materials include metals such as aluminum, copper, nickel and steel. The vessel 100 can also be formed from a coated metal such as anodized aluminum or nickel plated aluminum. The vessel 100 can also be formed from a metal coated with a dielectric material. In some embodiments of the invention the vessel 110 is formed from a dielectric material, and is surrounded by heat sink materials to assist cooling of the dielectric material.

The vessel 110 includes at least one dielectric region, for example, at the mating surface 116, which electrically isolates a portion of the vessel 110 so that electrical continuity around the vessel 110 is broken. If the vessel is formed entirely of dielectric material, the vessel 110 can be formed of a single piece of material, having no joined surfaces, and thus not including the mating surface 116.

Joined surfaces of the vessel 110 can provide a high vacuum seal. The seal can include an elastomer seal or can be a permanent seal such as a brazed joint. A seal can include metal.

As shown, magnetic cores 102, 104, 106, 108 surround portions of the vessel 110, i.e., portions of the channel 114. The magnetic cores 102, 104, 106, 108, together with primaries (not shown) of a transformer, induce an electric field and a current aligned with the channel 114, as described, for example, in U.S. Pat. No. 6,150,628 to Smith et al. A plasma in the channel 114 completes a secondary circuit of the transformer.

The transformer can include additional magnetic cores and conductor primary coils that form additional secondary circuits. The primary coils can be powered, for example, by an AC power supply having a frequency, for example, in a range of less than 10 kHz to greater than 20 MHz. The choice of frequency will depend on the desired power and voltage to be applied to the plasma.

The selection of optimal operating frequency can depend on the application, the AC power supply, and the magnetic core materials. Gases such as oxygen and nitrogen, for example, having a pressure in a range of 1 torr to 10 torr can be utilized with particular advantage at a frequency from 50 KHz to 14 MHz.

The magnetic cores 102, 104, 106, 108 can have primary windings that are adjustable. This can permit, for example, the voltage and current applied to the plasma to be optimized for ignition and for a particular process operating condition (for example, for particular pressure, flow rate and gas species conditions).

Electrical components can be in a circuit path between an output of the AC power supply and an input of the primary of the magnetic cores 102, 104, 106, 108. These components can include resistors, capacitors, and/or inductors. For example, a series inductor can be used to smooth a voltage waveform applied to the plasma, and thus improve plasma stability.

The components can be fixed or variable, with variability controlled, for example, via electrical or mechanical means. The components can form an impedance altering circuit or an impedance matching network.

A resonant circuit at the output of or built into the AC power supply can be used to raise an ignition voltage and the loop voltage (i.e., the voltage drop along the channel) for ignition purposes.

A DC power source connected to an input of the AC power supply can be obtained via rectification and filtering of an AC line voltage. The DC power source voltage can be regulated via additional circuitry to stabilize the voltage applied to the plasma and to provide regulation relative to variability in AC line voltage. The DC source voltage and current can also be used to control the power delivered to the plasma.

It can be desirable to monitor various parameters, such as power, current and voltage. Power delivered to the plasma can be estimated, for example, by measuring the power output by the DC power source. Power measurement can be refined by measuring or estimating electrical losses in the electrical elements disposed between the output of the DC power source and the plasma. Power can also be measured, for example, at the output of the AC power supply.

Power delivered to the plasma can be controlled via several means, for example, by varying: the magnitude of the DC power source voltage; the peak current applied to the plasma; the duty cycle of the AC power applied to the plasma; the magnitude of the AC voltage applied to the plasma; and the frequency of the AC power applied to the plasma. The efficiency of the power transfer between the output of the AC power supply and the plasma can be varied to vary the power applied to the plasma.

To reduce cost and complexity of a plasma source and its AC power supply and control system, these components can be integrated into a single enclosure. Alternatively, to increase flexibility, the plasma source can be separated from any of the following: the AC power supply, the DC power source, and the control system. A dielectric plasma vessel and related cooling and mounting components can be separated from other components to assist component replacement in the field.

The shape of the vessel 110 can take on a variety of forms. For example, the vessel 110 can be a square donut shape (as shown), a rectangular donut shape, a round donut shape, etc.

In operation, a feed gas flows into the gas inlet 118. A gas can be fed into the channel 114 until a pressure between, for example, 0.001 torr and 1000 torr is reached. The gas can include an inert gas, a reactive gas or a mixture of at least one inert gas and at least one reactive gas. The gas composition can be varied, for example, by providing one composition for ignition and a second composition for process operating conditions. Portions of the plasma can be delivered from the channel 114 via the outlet 119.

In some embodiments, a plasma system is configured so that little or none of the ionized species leaves a plasma vessel. In other embodiments, some ionized species are delivered from a vessel, for example, to assist processing in a chamber in communication with the vessel. In still other embodiments, the vessel is integrated with a process chamber, so that plasma is generated within the chamber.

Once the gas is ionized, a plasma forms and completes a secondary circuit of the transformer. The electric field in the plasma can be in a range of less than 1 to greater than 100 volt/cm. If only noble gases are present in the vessel 110, the electric fields in the plasma can be as low as 1 volt/cm or less. If, however, electronegative gases are present in the chamber, the electric fields in the plasma can be considerably greater than 1 volt/cm.

Operating the vessel 110 with low electric fields in the channel 114 can be beneficial because a low potential difference between the plasma and the chamber can reduce erosion of the chamber by energetic ions and related contamination of a material being processed.

The vessel 110 can include means for generating free charges that provides an initial ionization event that ignites a plasma in the vessel 110. The initial ionization event can be a short, high voltage pulse that is applied to the plasma chamber. The pulse can have a voltage of approximately 500-20,000 volts, and can be approximately 0.1 to 10 microseconds long. The initial ionization event can also be generated by use of a high voltage pulse of longer duration, approximately 10 microseconds to 3 seconds, which can be an RF pulse. An inert gas, such as argon, can be inserted into the channel to reduce the voltage required to ignite a plasma. Ultraviolet radiation can also be used to generate the free charges in the vessel 110 that provide the initial ionization event that ignites the plasma in the vessel 110.

In one implementation, the short, high voltage electric pulse is applied to the primary of the magnetic cores to provide the initial ionization event. In another implementation, the short, high voltage electric pulse is applied to an electrode or electrodes positioned in or on the vessel 110. In yet another implementation, ignition can include one or more pulses to the primary of the magnetic core(s) and/or one or more pulses to the ignition electrodes. Ignition is described in more detail below, with respect to other illustrative embodiments of the invention.

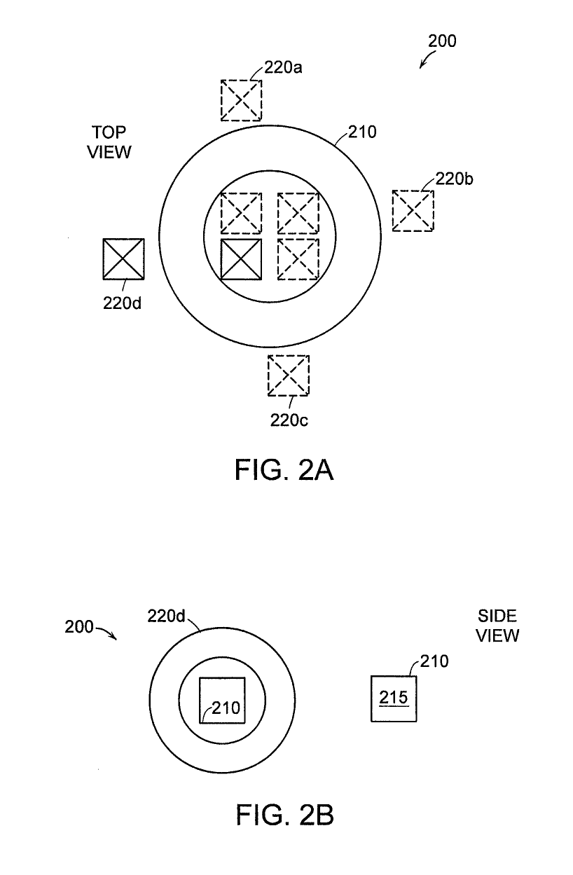

Now referring to FIGS. 2A and 2B, most embodiments described herein are directed at symmetrical, loop-shaped dielectric vessels, though principles of the invention can be applied to plasma systems having a variety of vessel configurations and materials components. Accordingly, the illustrative embodiments should not be construed as limiting implementations of the invention to systems that are symmetric or that include loop-shaped vessels, or to systems having vessels that are entirely formed from a dielectric material.

FIGS. 2A and 2B, respectively, are schematic top-view and side-view cross sections of an embodiment of a portion of a plasma system 200. The system 200 includes a vessel 210 and a magnetic core 220d (three optional magnetic cores 220a, 220b, 220c are shown in dashed lines). FIG. 2B illustrates a section through the magnetic core 220d and the vessel 210. Alternative implementations of the system 200 include two, three, or more than four magnetic cores.

The vessel 210 encloses a channel 215, which has a square cross-section shape and within which a plasma can be maintained. A vessel can have a non-square cross section. The vessel 210 is formed from a single piece of dielectric material. The dielectric material can be, for example, quartz, sapphire, alumina, aluminum, aluminum nitride, a yttrium oxide, a zirconium oxide, and/or ceramic materials. The vessel 210 can include a metal vessel coated with dielectric material. The material used to form the vessel 210 can be chosen based on planned applications for the system 200. For example, the material can be chosen based on a planned power of operation, plasma species and/or required purity level.

The vessel 210 supports a toroidal plasma, and has a circular donut shape with a square cross section. Other vessels that support a toroidal plasma can have a variety of shapes. Such shapes can include, for example, any of the following overall shapes: an elliptical donut shape; a square donut shape; a rectangular donut shape; and a polygonal donut shape, and can have, for example, a circular cross section or an elliptical cross section.

The vessel 210 can include one or more gas inlet ports and one or more outlet ports. Multiple ports can be included to provide additional control over the plasma in the vessel 210. Control of gas flow, in particular during ignition, is discussed below in more detail.

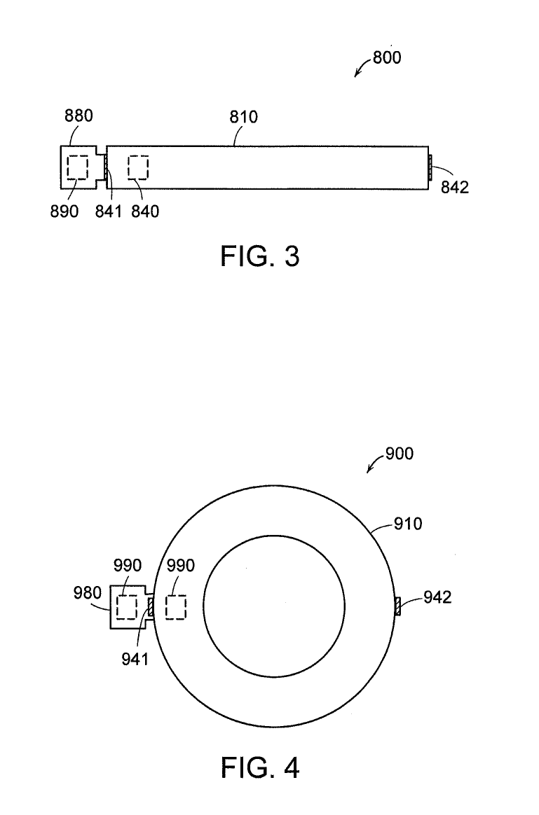

FIG. 3 is an embodiment of a plasma system 800 that includes a linear-shaped vessel 810, which defines a channel for containing a gas and has a gas input port 841 and an output port 842. The system 800 includes an upstream portion 880 in fluid communication with the input port 841 of the vessel 810. The system 800 also includes at least one ignition electrode 890 adjacent to the gas input port 841 for application of an electric field to a flowing gas proximate to the input port 841 of the vessel 810 (two alternative locations for an ignition electrode 890 are indicated by with dashed-line features). In various embodiments, an ignition electrode can be anywhere in the plasma vessel. In some embodiments, the ignition electrode adjacent to the gas input port is not necessary (e.g., a UV light source can be used for ignition).

As illustrated, the ignition electrode 890 can be located by a surface of the vessel 810 or by a surface of the upstream portion 880. The upstream portion 880 can be, for example, a flange for mating with a gas delivery pipeline. The upstream portion 880 and the vessel 810 can be formed from a single piece of material, for example, a single piece of fused quartz.

One or more ignition electrodes 890 can be upstream or downstream of the input port 841, or can overlap the input port 841. Methods according to the technology can be implemented, for example, with the system 800, can provide improved ignition. The ignition electrode 890 adjacent to the gas input port 841 can ignite a flowing gas in the vicinity of the site of gas entry into the vessel 810. The site of ignition, in cooperation with the flow of ionized components, can help to seed a plasma along the full channel.

FIG. 4 is an embodiment of a system 900 that includes a vessel 910 having a gas input port 941 and an output port 942. The vessel 910 defines a channel for containing a gas. The system includes an upstream portion 980 in fluid communication with the gas input port 941. The system 900 includes at least one ignition electrode 990 adjacent to the gas input port 941 for application of an electric field to a flowing gas proximate to the input port 941 of the vessel 910.

The system 900 has features similar to that of the system 800, however, with the linear vessel 810 replaced with the toroidal-shaped vessel 910. The system 900 can implement methods according to the technology, and provide the benefits described with respect to FIG. 3.

As indicated above, an upstream ignition site can seed electrons into an incoming gas stream. The electrons can then flow with the gas along the channel and assist, for example, inductive ignition of a plasma. The method 700 and systems 800, 900 can provide reduction of plasma system manufacturing costs, easier field service, and provide reduced erosion of an inner surface of a vessel 810, 910.

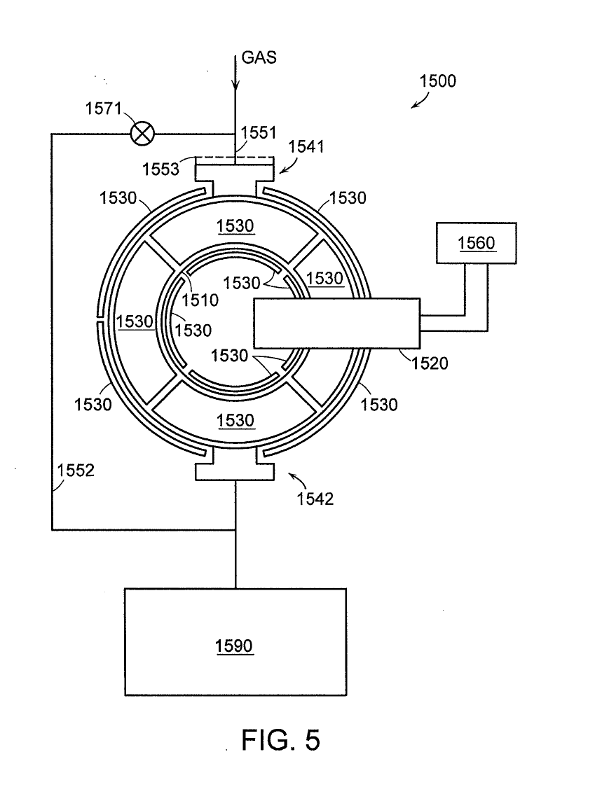

FIG. 5 is a block diagram of an embodiment of a plasma processing system 1500 that includes structural features of the invention described above. The system 1500 includes a dielectric vessel 1510 surrounded by at least one magnetic core 1520 that is in electrical communication with an AC power supply 1560. The dielectric vessel 1510 has a gas input port 1541 and an output port 1542. Sixteen heat-sink segments 1530 are positioned around the dielectric vessel 1510, and can also serve as electrodes, e.g., ignition and/or reference electrodes. Alternatively, ignition and/or reference electrodes can reside between the segments 1530 and the vessel 1510.

The one or more magnetic cores 1520 have windings that act as primaries of a transformer to induce an electric field and a plasma current aligned with the channel defined by the dielectric vessel 1510. A plasma in the channel completes a secondary circuit of the transformer. Some implementations of magnetic cores and associated AC power supplies that can support a toroidal plasma are described in U.S. Pat. No. 6,150,628 to Smith et al.

The vessel 1510 has a square cross section, and four of the heat-sink segments 1530 are adjacent to each of four surfaces defined by the vessel 1510 (i.e., upper, lower, inner, and outer surfaces). The segmentation of the heat sink aids assembly and accommodates thermally induced dimensional changes.

The system 1500 also includes a gas input pipeline 1551 in communication with the input port 1541, a bypass gas pipeline 1552, a bypass valve 1571, and a process vessel 1590 defining a process chamber in communication with the output port 1542 of the dielectric vessel 1510. To implement the method 1000, the bypass valve 1571 can direct a portion or all of a gas flow from the input pipeline 1551 to the bypass gas pipeline 1552 during plasma ignition. The system 1500 can include a gas showerhead 1551 in or near the input port 1541 to mediate flow of gas from the pipeline 1151 into the input port 1541.

The inclusion of the gas showerhead 1551 can improve stability of a plasma and the uniformity of heat distribution onto the inside surface of the vessel. The gas showerhead 1551 can improve the distribution of gas directed through input port 1541 into the toroidal channel.

The technology can include, and/or be used in conjunction with, related methods and apparatus (e.g., U.S. Patent Application Publication No. US 2006/0118240 by Holber et al. and U.S. Pat. No. 6,872,909 by Holber et al., which disclose methods and apparatus for downstream dissociation of gases and a toroidal low-field reactive gas and plasma source having a dielectric vacuum vessel, and which are incorporated herein by reference).

In various embodiments, the technology features a method for operating a plasma. An oxygen containing plasma is generated. The plasma is provided to a plasma vessel including quartz, sapphire, aluminum and/or a dielectric material to clean and/or condition the vessel.

In some embodiments, the technology features a method for operating a plasma. An oxygen containing gas is received in a plasma vessel including quartz, sapphire, and/or aluminum. An oxygen containing plasma is formed. The plasma cleans and/or conditions the vessel.

In certain embodiments, the technology features a method including receiving an oxygen containing plasma in a vessel, including quartz, sapphire, and/or aluminum, to clean and/or condition the vessel.

In various embodiments, the technology features a method for operating a plasma. An oxygen containing plasma is provided to a vessel including quartz, sapphire, and/or aluminum. The plasma chemically and/or thermally interacts with the vessel to add oxygen to a surface of the quartz, sapphire, and/or aluminum.

In some embodiments, the technology features a method including providing an oxygen containing plasma to a vessel including quartz, sapphire, and/or aluminum. The plasma chemically and/or thermally interacts with a contaminant in the vessel to remove the contaminant from a surface of the quartz, sapphire, and/or aluminum.

In various embodiments, the degree of cleaning and/or conditioning of the quartz, sapphire, and/or aluminum vessel can depend upon parameters of the oxygen containing plasma including a pressure, flow rate, power, and/or time. In one embodiment, the oxygen containing plasma conditions the vessel. Conditioning can include the plasma chemically and/or thermally interacting with the vessel to add oxygen to a surface of the quartz, sapphire, and/or aluminum. In another embodiment, the oxygen containing plasma cleans the vessel. Cleaning can include removing atoms from a surface of the vessel, which can remove undesired molecules from a surface of the vessel. Undesired molecules can include organic compounds. In yet another embodiment, cleaning can include removing contamination from the vessel by removing atoms from a surface of the vessel. In still another embodiment, cleaning can include removing contamination from the vessel by chemically and/or thermally interacting with contamination on a surface of the vessel.

In some embodiments, an oxygen containing plasma can chemically reduce undesired hydrogen products on the surface of the SiO₂ or Al₂O₃ vessel, restoring the SiO₂ or Al₂O₃ surface. In certain embodiments, an oxygen containing plasma can remove or “burn off” hydrogenated or hydrated surface molecules (e.g., Si(OH)₄) before they build up, and/or accumulate and break off and form particles.

In various embodiments, the technology includes methods that can be used in conditioning/cleaning newly manufactured quartz and/or sapphire vessels. A new vessel can produce an unacceptable amount of particles upon turn on if it is not conditioned/cleaned before use. A new vessel can produce an unacceptable amount of particles within about the first one to about ten hours of operation. Conditioning/cleaning a new vessel according to methods of the technology can reduce particle counts to an acceptable operating level.

In some embodiments, the technology includes methods that can be used in situ to clean and/or condition quartz and/or sapphire vessels. A vessel can become contaminated from environmental sources (e.g., sources other than the gas or plasma deliberately flowed into the vessel) including environmental dust and/or dirt.

In certain embodiments, the technology includes methods where one vessel can be used to clean and/or condition another vessel. A vessel can be remanufactured and/or reconditioned.

The surface of the quartz, sapphire, and/or aluminum vessel can be damaged by a plasma that can react with SiO₂ or Al₂O₃, to remove and/or replace oxygen atoms on the surface of the quartz, sapphire, and/or aluminum. However, operating an oxygen containing plasma can form oxygen radicals and/or ions, which can react with SiO₂ or Al₂O₃, to refill, repair and/or replace oxygen atoms on the surface of the quartz, sapphire, and/or aluminum.

Hydrogen or hydrogen containing plasmas (e.g., H₂/N₂, NH₃, and/or H₂O) can react with a surface of a vessel. This reaction can damage and/or form particles on the surface of the vessel. The particles can include silicon, silicon nitrides such as SiₓN_{y}, and/or silanols such as Si(OH)₄.

Water vapor plasma can react with a surface of a vessel. This reaction can form particles on the surface. The particles can include silicon hydroxides and silicon oxides such as Si(OH)₄ and SiO₂. The formation of particles can degrade the surface and/or form deposits. Deposits can come off of the surface and exit the vessel as undesired particles, which can affect semiconductor processing rates.

Hydrogen containing plasmas (e.g., H₂/He, Ar/H₂, H₂, NH₃, and/or H₂O) can react with a surface of a sapphire vessel. This reaction can form particles on the surface. For example, the hydrogen containing plasma can remove oxygen from Al₂O₃ and can form aluminum particles and/or a layer of metallic aluminum on the surface. The formation of particles can degrade the surface and/or form deposits. Deposits can come off of the surface and exit the vessel as undesired particles, which can affect semiconductor processing rates.

Operating an oxygen containing plasma in the quartz, sapphire, and/or aluminum vessel can re-oxidize the damaged vessel surface. In various preferred embodiments, an oxygen containing plasma is operated to clean, condition, and/or repair a quartz, sapphire, and/or aluminum vessel immediately after exposure to the damaging plasma. In other embodiments, an oxygen containing plasma is operated to clean, condition, and/or repair a quartz, sapphire, and/or aluminum vessel during or after exposure to the damaging plasma.

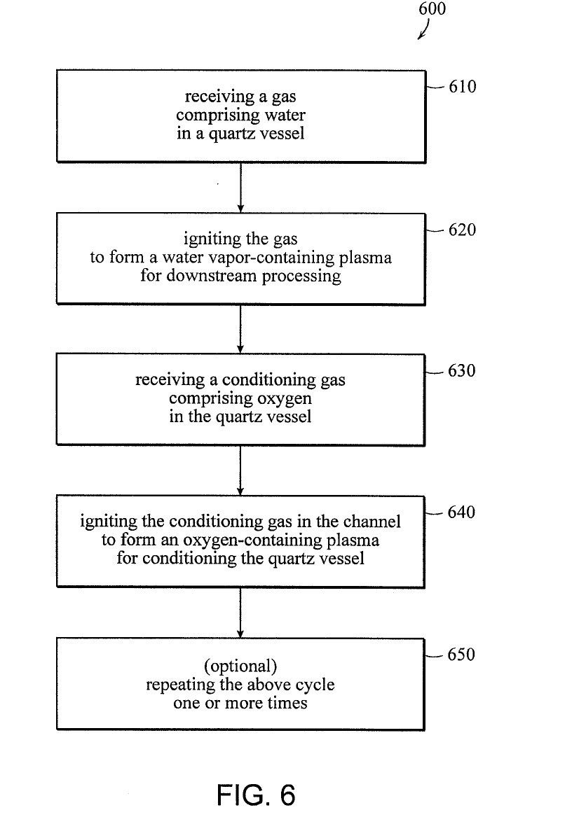

FIG. 6 is a flowchart of an embodiment of a method 600 for operating a plasma. The method 600 includes the steps of receiving a gas comprising water in a vessel 610; igniting the gas to form a water vapor containing plasma for downstream processing 620; receiving a conditioning gas comprising oxygen in the vessel 630; and igniting the conditioning gas in the channel to form an oxygen containing plasma for conditioning the vessel 640. Optionally, the method 600 can include an additional step of repeating steps 610, 620, 630, and 640 one or more times 650.

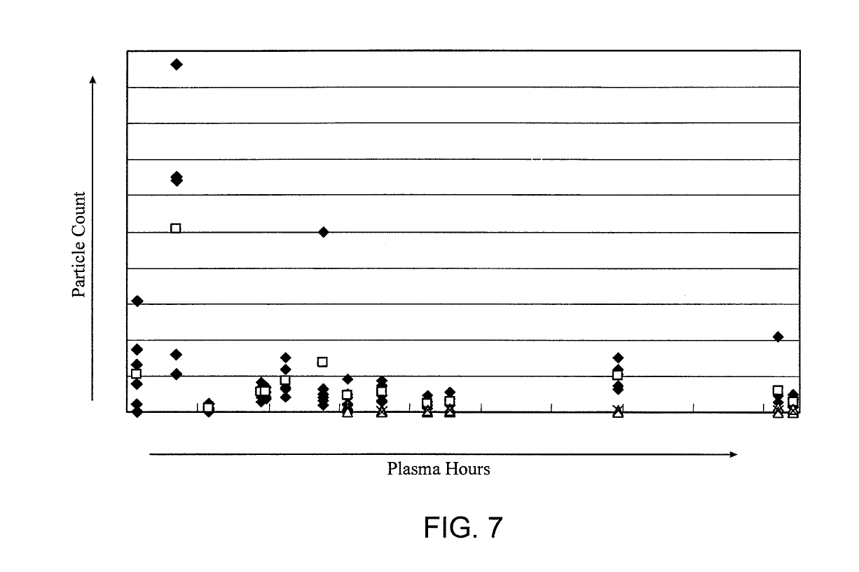

FIG. 7 shows a particle count as a function of plasma operation time in a quartz vessel. Data can be collected by running an O₂/N₂ plasma in a R*EVOLUTION™ (MKS Instruments, Inc. of Wilmington, Mass.) remote plasma source without water vapor. The plasma source can be operated at power of up to about 6 kW with a flow rate of about 0.5 to about 8 standard liters per minute (slm) at a pressure of about 0.5 to about 5 torr. The ratio of O₂ to N₂ can be about 90% to about 10%. The particle count can remain at an acceptable level (e.g., below about 50), even after about 1000 hours of continuous plasma operation.

In various embodiments, the method includes a recipe for operating a plasma in the quartz, sapphire, and/or aluminum vessel with one or more steps.

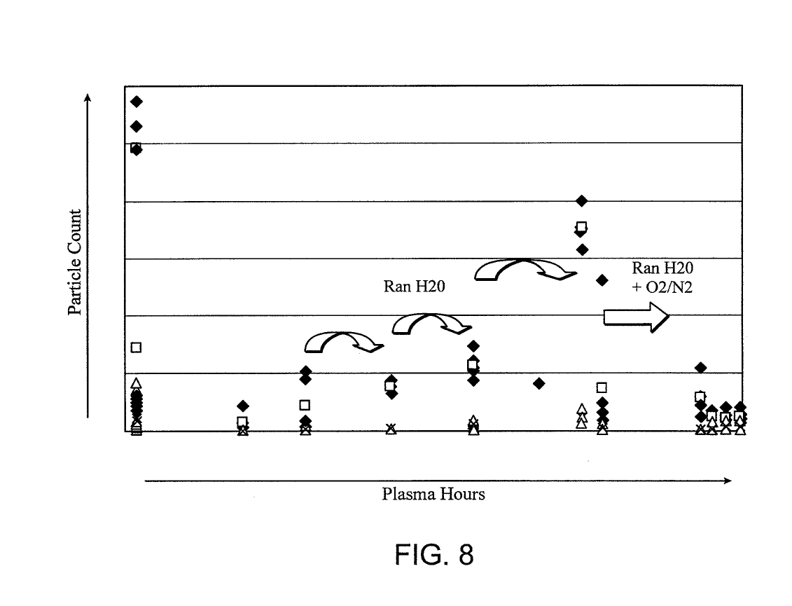

FIG. 8 shows a particle count as a function of plasma operation time in a water vapor containing plasma with an oxygen containing plasma. The vessel can be quartz. The abnormally high initial particle count is due to us of a new (e.g., unconditioned) plasma vessel and is not related to steady state plasma operation. As the number of plasma hours increases, the particle count can increase many times above an acceptable level (e.g., above about 50). After the particle count increases above an acceptable level, a mixture of oxygen and nitrogen can be ignited within the plasma vessel at a power of up to about 6 kW and run for several hours to reduce the particle count. After running the oxygen containing plasma, particles can remain at or below an acceptable level. Without an oxygen containing plasma step, particles can rise to unacceptable levels after tens of plasma hours.

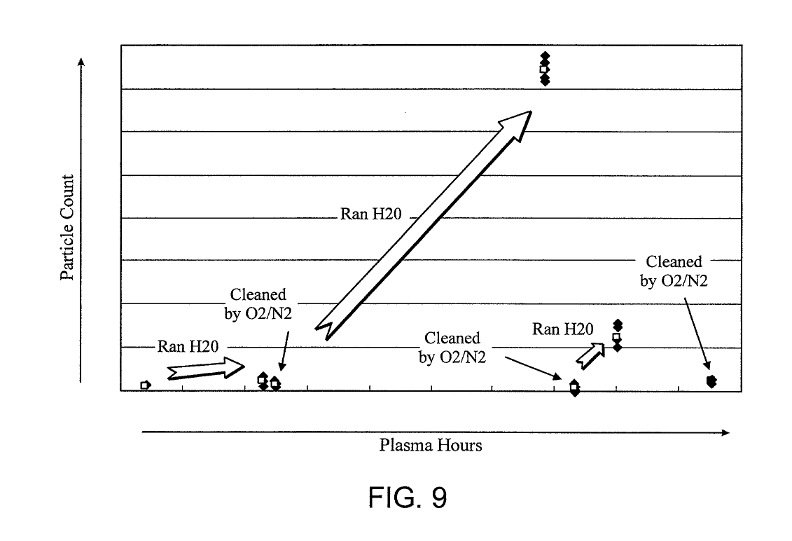

FIG. 9 shows a particle count as a function of plasma operation time in a water vapor containing plasma with an oxygen containing plasma. The plasma source can be operated at power of up to about 6 kW with a flow rate of about 0.5 to about 8 slm at a pressure of about 0.5 to about 5 torr. The ratio of O₂ to N₂ can be about 90% to about 10%. The plasma can operate in up to a 100% duty cycle. In some cases, it can be beneficial to operate the plasma in lower duty cycles, such as 50% on/50% off. An on/off cycle can last for seconds, minutes, or hours. The combination of oxygen-containing plasma cycles with water vapor containing plasma cycles can keep the plasma vessel clean and/or keep particles at or below and acceptable level.

In certain embodiments, operating oxygen containing plasmas in quartz, sapphire, and/or aluminum vessels can increase the operating life of the vessel. In one embodiment, an oxygen plasma process can increase the lifetime of a quartz tube with water vapor plasma from about tens to at least about 1,000 hours. Oxygen containing plasma conditioning can increase the lifetime of a quartz, sapphire, and/or aluminum vessel to more than about 1,000 hours.

In various embodiments, cooling of the quartz, sapphire, and/or aluminum vessel, in addition to operating an oxygen containing plasma, can further reduce particle count during operation of a plasma.

In some embodiments, decreasing an operating power of the plasma, in addition to operating an oxygen containing plasma, can further reduce particle count during operation of a plasma. For example, decreasing power from about 5-6 kW (high power) to about 3.5 kW (moderate power) can reduce the incidence of particles in water vapor plasmas.

In certain embodiments, operating an oxygen containing plasma can have advantages in addition to reducing particle count during operation of a plasma. For example, operating an O₂/N₂ plasma can be useful in applications including etching.

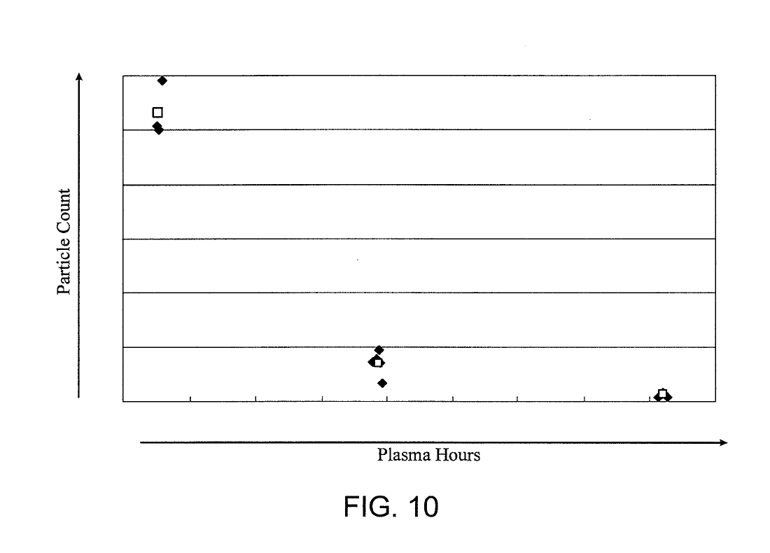

FIG. 10 shows a particle count as a function of plasma operation time in a new plasma vessel. A new R*EVOLUTION™ (MKS Instruments, Inc. of Wilmington, Mass.) plasma vessel can be used to operate an oxygen containing plasma with a power of up to about 6 kW with a flow rate of about 0.5 to about 8 slm at a pressure of about 0.5 to about 5 torr. The ratio of O₂ to N₂ can be about 90% to about 10%. The plasma can operate in a duty cycle between about 50% to about 100%. In the first few plasma hours, the particle count can be above an acceptable level. After about 10 hours or less of oxygen containing plasma conditioning, the particle count can be lowered to an acceptable level.

In various embodiments of the invention, including those described above, operating an oxygen containing plasma can improve ignition performance. For example, operating an oxygen containing plasma in combination with a plasma for downstream processing can improve ignition performance. In one embodiment, a photoresist strip process recipe includes a processing gas that includes a forming gas. In some applications, a forming gas is a mixture of hydrogen in nitrogen (for example, a mixture of up to 10% hydrogen in nitrogen). In some embodiments, a forming gas is used as an atmosphere for processes that need the properties of hydrogen gas without the explosion hazard. In some embodiments, the forming gas includes a mixture of 4% hydrogen in nitrogen.

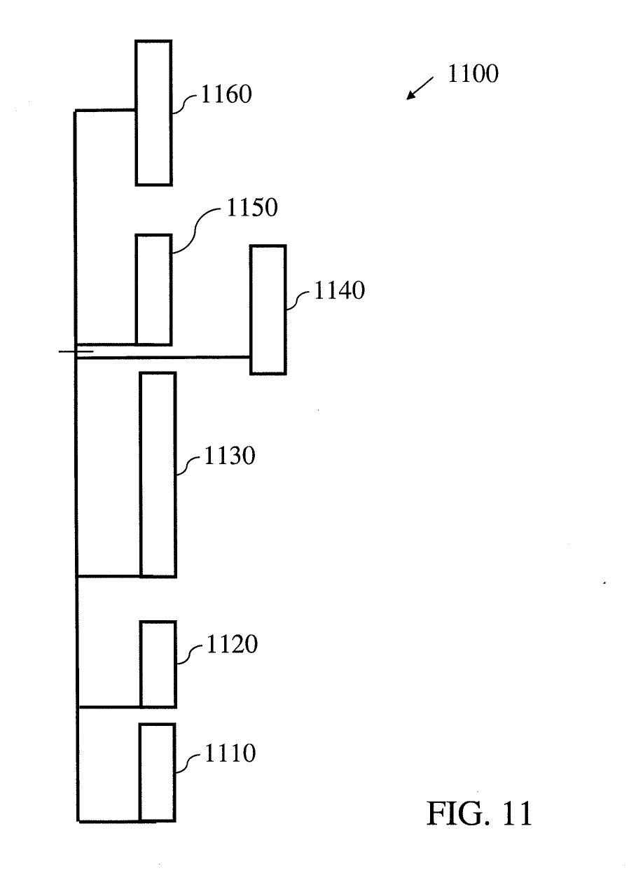

FIG. 11 is a flowchart of a method 1100 for operating a plasma. Aspects of the method improve the plasma ignition performance. The method can be implemented, for example, in a R*EVOLUTION™ plasma vessel. The method 1100 includes the step 1110 of stabilizing a first gas in a plasma vessel. In one embodiment, the first gas is stabilized at a pressure of 1.3 Torr for about 15 seconds. The method 1100 also includes the step 1120 of igniting the first gas to generate a plasma for downstream processing. In one embodiment, the plasma is ignited over a period of about 20 seconds.

The method 1100 also includes the step 1130 of operating the plasma to provide, for example, dissociated gases for downstream processing. In some embodiments, the plasma is generated and the dissociated gases are generated for downstream processing for about 40 seconds. During this period of time ignition properties of the plasma can be measured and compared to evaluate improvements to the ignition process. The method 1100 also includes the step 1140 of generating a conditioning plasma to improve ignition in subsequent processing steps. In some embodiments, the conditioning plasma is generated using a gas including oxygen. In some embodiments, the step 1140 is conducted for a period of about 2 seconds. Step 1140 conditions the plasma vessel which improves subsequent processing steps in which the plasma is reignited.

The method 1100 also includes the step 1150 in which the plasma and gas are turned off for 45 seconds. In some embodiments, steps 1110, 1120, 1130, 1140, and 1150 are repeated for one or more cycles. In some embodiments, the method includes optional step 1160, in which the plasma vessel is allowed to idle for 10 min after 25 cycles have been performed for steps 1110, 1120, 1130, 1140, and 1150.

In various embodiments, method 1100 can be adapted for different processing recipes. For example, step 1110 can include a gas at a pressure suitable for a desired process. Likewise, the durations of the individual steps, the number of cycles, and the idle time (if any) can be selected to suit a desired process.

While the invention has been particularly shown and described with reference to specific preferred embodiments, it should be understood by those skilled in the art that various changes in form and detail can be made therein without departing from the spirit and scope of the invention as defined by the appended claims.

1. A method for operating a plasma comprising:
receiving a first gas in a vessel;
igniting the first gas to generate a plasma for downstream processing;
receiving a conditioning gas comprising oxygen in the vessel; and
generating an oxygen containing plasma in the vessel.

2. The method of claim 1, wherein the first gas comprises a forming gas.

3. The method of claim 1, wherein the first gas comprises hydrogen.

4. The method of claim 1, further comprising extinguishing the plasma after generating the oxygen containing plasma.

5. The method of claim 1, further comprising reigniting the first gas to re-generate the plasma for downstream processing.

6. A method for operating a plasma comprising:
providing a vessel defining an enclosed channel, the vessel comprising at least one of quartz, sapphire, and aluminum;
providing a first gas;
directing at least a portion of the first gas into the channel;
igniting the first gas to generate a plasma for downstream processing;
providing a conditioning gas comprising oxygen;
directing at least a portion of the conditioning gas into the channel; and
generating an oxygen containing plasma for conditioning the vessel.
